(19) United States
(12) Patent Application Publication
(10) Pub. No.: US 2003/0059749 A1
(43) Pub. Date: Mar. 27, 2003

(54) Method for training advisors to students in highly mobile populations

(76) Inventor: Mary M. Keller, Harker Heights, TX (US)

Correspondence Address: DAVID G. HENRY, 900 Washington Avenue, P.O. Box 1470, Waco, TX, 76701, US

(21) Appl. No.: 10/083,628

(22) Filed: Feb. 26, 2002

Related U.S. Application Data
(63) Continuation-in-part of application No. 09/965,132, filed on Sep. 26, 2001.

(51) Int. Cl. G09B 19/00

(52) U.S. Cl. 434/236

(57) ABSTRACT

The invention is of a method or process by which persons are educated and trained to effectively confront issues and circumstances which affect children of mobile families or populations, to publicize the plight of such children in order to affect public opinion and policy, to directly counsel affected children and their families, and to act as a liaison between affected children and families and the schools involved in a student relocation. A person so trained shall be known as a “transition counselor.”

This is a continuation-in-part application with respect to U.S. patent application Ser. No. 09/965,132, filed Sep. 26, 2001 from which priority is claimed pursuant to 35 U.S.C. §120.

### BACKGROUND OF THE INVENTION

1. Field of the Invention

The present invention relates to training counselors or advisors of children, and in particular, of children who suffer, as they move from one geographic area to another, the consequences of differences between school districts and states as reflected in incompatible curricula, differing school year calendars, disparate graduation requirements, non-standardized grading standards, and the like.

2. Background Information

Children who move from-state to state, or even school district to school district within a single city, often endure emotional challenges and educational obstacles which, if fully realized and understood by society, would likely create an uproar not much less than that associated with child abuse. This would not be inappropriate because the trauma suffered by many children, simply because they move from one school to another, can have just as long-lasting an effect on the child as certain kinds of abuse, and the emotional trauma is likewise often comparable.

The comparison between child abuse and the pain and obstacles suffered by children moving from one school to another (particularly if this happens frequently, as with military and highly mobile professional families) is not an exaggeration. If, at one point in time, a parent were to set certain standards and codes of behavior for a child, with the child naturally adapting his or her behavior, thinking and daily routine accordingly, with the parent later completely changing the standards and severely penalizing the child for failing to immediately conform to the new and disparate standards, such would doubtless be considered a form of mental abuse by many. Yet, this is precisely the nature of the experience faced by children as they move from school to school.

Considering only the military dependant children as indicators of the scale of the problem in this country, (to which mobile professionals, etc. would have to be added to fully grasp the scale), consider the following:

1.3—1.4 million children, ages birth to 21 years, are dependants of U.S. active duty, uniformed service members.

The number of school-aged, military-connected students is estimated at 800,000. These children are educated in the public schools in the United States (600,000), in the Department of Defense (DODEA) schools worldwide (100,000) and in other school settings (100,000).

Military-connected students move an average of once every 2.9 years, and attending between 6 and 9 different schools during the K through 12th grade years.

Factors which greatly exacerbate the inherent upheaval of a family move for a school aged child include:

Challenges related to the transfer and interpretation of school records.

Disparities in the ways in which schools and school systems organize time and course progressions (school year calendars, school day-schedules, and grade levels at which certain “core subjects” are covered, for example).

Disparities from one school system (or state) to another relating to graduation requirements, prerequisite requirements, grading variations, tiered diplomas, and state's or district's “high stakes” exit or advancement testing.

Disparate prerequisites for participation in extracurricular and enrichment programs.

Varying eligibility requirements for, and availability of, special education programs and variations in program availability and content.

Lack of consistent elementary and middle school opportunities for students to develop necessary academic concepts and skills.

Inadequate understanding by adults of the social and emotional needs of the student in transition or the military-connected student coping with separation from or deployment of a parent(s).

Absence of reliable presence of a child-centered climate of understanding and acceptance supported by a strong and meaningful partnership between military installations and the supporting school system(s).

After repeated and frustrating failures, persons directly affected by the plight of children of mobile families came to the realization that the problems for their children would not, and could not be effectively addressed without placement in the field of specifically trained professionals who can deal with the affected children, as well as educate others in doing so.

In view of the above, it would literally serve all humankind to provide a new and uniquely effective method or process by which persons are educated and trained to effectively confront issues and circumstances which affect children of mobile families or populations, to publicize the plight of such children in order to affect public opinion and policy, to directly counsel affected children and their families, and to act as a liaison between affected children and families and the schools involved in a student relocation.

### SUMMARY OF THE INVENTION

In view of the foregoing, it is an object of the present invention to provide a method or process for training persons to counsel and guide school age children and their parents in relation to challenges and obstacles attending to move from one school district to another, when such districts have disparate curricula, school year calendars, graduation requirements, and/or grading standards, etc.

It is another object of the present invention to provide a method or process for training persons to effectively confront issues and circumstances which affect children of mobile families or populations.

It is another object of the present invention to provide a method or process for training persons to publicize the plight of children of mobile families or populations in order to effect advantageous changes in public opinion and policy.

It is another object of the present invention to provide a method or process for training persons to directly counsel children and families affected by relocations between schools with disparate calendars, scholastic standards, graduation requirements, etc.

It is another object of the present invention to provide a method or process for training persons to act as a liaison between children and families affected by school relocation situations and the schools involved in a student relocation.

In satisfaction of this object, the present invention provides a method by which persons are educated of the issues to be confronted, and trained to address the issues faced by children who move between school districts.

### DETAILED DESCRIPTION OF THE METHOD

The present invention is of a business method or process by which persons are educated and trained to effectively confront issues and circumstances which affect children of mobile families or populations, to publicize the plight of such children in order to affect public opinion and policy, to directly counsel affected children and their families, and to act as a liaison between affected children and families and the schools involved in a student relocation. A person so trained shall be known as a “transition counselor.”

The model for the method is based on educating “transition counselors” in relation to children of military families, but alterations of the method which are appropriate to other, similarly affected populations, will be apparent to those skilled in the relevant fields, and will fall within the scope of the present business method invention.

The present method is in the nature of a training seminar, known as the “transition counselor institute” (“TCI”). Attending and successfully completing a TCI institute will result in the participant receiving a certification and (upon approval by state and local regulatory authorities) “in-service training” credit.

The following outlines a seminar within the scope of the present invention, and includes two phases:

### DESCRIPTION OF PHASE I

Phase I Objectives and Organization

1. The objectives of TCI Phase I are to:

a. Introduce participants to the children and families of the subject, highly mobile population (military families, for example);

b. Increase awareness of the challenges of mobile students;

c. Identify the “sending” and “receiving” school responsibilities focusing on the perspectives of parents, students, and counselors/teachers;

d. Discuss innovative ways to involve parents and keep them informed;

e. Address critical issues (disparate graduation requirements, non-standardized grading standards, differing calendars, non-standardized school records keeping, emotional effects on relocated children which are compounded by needless “red tape” and educational barriers, etc.);

f. Provide data based upon current research;

g. Explore proven practices and procedures for easing student transitions;

h. Increase awareness of the differences in school requirements;

i. Build a network of trained transition counselors; and

j. Explore web sites and share important web addresses.

2. TCI Phase I is a course offered primarily to practicing middle school and high school counselors, counselor supervisors, or persons particularly interested in the transitions of mobile students.

3. TCI Phase I Organization

a. Compilation of scenarios for introducing the military lifestyle and for understanding “sending and receiving” school responsibilities;

b. Collaboration with colleagues in discussing involvement of parents, sharing proven practices and procedures, discovering differences in school requirements, and building networks of school counselors;

c. Presentation by trainers of current research and critical issues;

c. Computer interaction process for building networks;

Phase I Requirements

1. Phase I Attendance Requirements.

a. Attendance is expected to receive credit for TCI Phase I. The success of the course depends upon participants' interaction.

b. Absences will negate credit.

2. Phase I Preparation and Participation.

a. TCI Phase I is a short, intense institute that is dependent upon your full participation. The participant is expected to evaluate documents provided by trainers, provide examples of “best practices” and ideas used at the participants' schools.

b. Participation in the discussion and group collaboration is expected.

3. Phase I Graded Work.

a. 40%—Participation in group discussion and activities

b. 30%—Collaborative effort—product and presentation

c. 30%—Develop a sample “portfolio” that will be useful for mobile students as they move from school to school, provide step-by-step guidelines to access your school's web site or provide step-by-step guidelines to access a useful web site that contains information of importance to counselors.

4. Phase I Resources.

a. Keller, Mary M. and Decoteau, Glynn T., The Military Child: Mobility and Education. Phi Delta Kappa Educational Foundation, Fastback n463, 2000.

b. Keller, Mary M., U.S. Army Secondary Education Transition Study (SETS)

c. Working with Military Children, A Primer for School Personnel. A Project of the Virginia Joint Military Family Services Board.

### DESCRIPTION OF PHASE II

Phase II Objectives and Organization

1. Phase II Oblectives.

a. Increase understanding of the life of mobile military children and the military culture using current data and selected readings

b. Explain deployment and separation and explain the impact that these have on military children

c. Discuss school support systems and programs

d. Identify resources and family support systems available for school personnel and military families

e. Develop a school support system that addresses the critical first two weeks of school and beyond

f. Build upon the TCI Phase I Network

2. TCI Phase II is a course offered primarily to practicing middle school and high school counselors, counselor supervisors, or persons particularly interested in the transitions of mobile students.

3. Phase II organization.

a. Book study of two selected readings, Military Brats and Invisible Women;

b. Round table discussion of current school support systems;

c. Collaborative project to develop a support system for the critical first two weeks;

d. Providing content to be used on the TCI web site newsletter.

Phase II Requirements

1. Attendance.

a. Attendance is expected to receive credit for TCI Phase II. The success of the course depends upon participants' interaction.

b. Absences will negate credit.

2. Phase II Preparation and Participation.

a. TCI Phase II is a short, intense institute that is dependent upon students' full participation. The participant is expected to evaluate documents provided by trainers, provide examples of “best practices” and ideas used at the participants' schools.

b. Participation in the discussion and group collaboration is expected.

3. Phase II Graded Work.

a. 40%—Participation in group discussion and activities

b. 30%—Collaborative effort—product and presentation c. 30%—Reflections of two required readings and one optional reading.

c. Students will be required to prepare a three-page review/reflection of the required readings and submit these to the TCI Coordinator no later than Aug. 15, 2001. An additional one-page paper shall be submitted that discusses positive recommendations to help transitioning students who enter your school just before their senior year.

4. Phase II Resources.

a. Harrell, Margaret C., Invisible Women, Junior Enlisted Army Wives, 2000. RAND, Arlington, Va.

b. Keller, Mary M., U.S. Army Secondary Education Transition Study (SETS)

c. Wertsch, Mary E., Military Brats, Legacies of Childhood Inside the Fortress, 1991. Aletheia Publications, Bayside, N.Y.

d. Working with Military Children, A Primer for School Personnel. A Project of the Virginia Joint Military Family Services Board.

Although the invention has been described with reference to specific embodiments, this description is not meant to be construed in a limited sense. Various modifications to, or alternative embodiments of, the present invention will become apparent to persons skilled in the art upon the reference to the description of the invention. It is, therefore, contemplated that the appended claims will cover such modifications that fall within the scope of the invention.

I claim:

1. A method for training transition counselors comprising the steps of:
assembling individuals for training and education about issues and problematic circumstances facing children and families of children who are, as a result of relocations between schools, faced with educational and social impediments;
instructing said individuals in educational barriers facing mobile students, including disparate school calendars, disparate grading standards between schools, disparate graduation requirements among schools;
conducting group discussions concerning said educational barriers;
requiring participants, as a condition of accreditation as a transition counselor, the reading of materials pertaining to said educational barriers; and
instructing said individuals in methods for countering said educational barriers.
